(19) United States
(12) Patent Application Publication
(10) Pub. No.: US 2008/0248680 A1
(43) Pub. Date: Oct. 9, 2008

(54) POWER CABLE CONNECTOR

(75) Inventors: Stuart Stoner, Lewisberry, PA (US); Christopher J. Kolivoski, Lewisberry, PA (US)

Correspondence Address: WOODCOCK WASHBURN, LLP, CIRA CENTRE, 12TH FLOOR, 2929 ARCH STREET, PHILADELPHIA, PA, 19104-2891, US

(73) Assignee: FCI Americas Technology, Inc.

(21) Appl. No.: 12/054,023

(22) Filed: Mar. 24, 2008

Related U.S. Application Data
(60) Provisional application No. 60/910,178, filed on Apr. 4, 2007.

(51) Int. Cl. H01R 13/627; H01R 11/00; B23P 11/00

(52) U.S. Cl. 439/357; 439/502; 29/428

(57) ABSTRACT

This invention relates to an improved power connector that has a housing comprising a plurality of slots that are each for receiving a receptacle contact. Preferably, the housing has a plurality of quick-disconnect contacts each disposed in one of the housing slots. Further, a cover, may be coupled to the housing, and the housing may comprise a top portion and a bottom portion. A strain relief member, may be disposed between the cover top and bottom portions. A plurality of cables extend through the channels disposed in the strain relief members and are attached to the housing quick disconnects. A latching spring assembly that may comprise two latching springs is coupled to the housing and attaches the power cable connector to a receptacle connector, such as a right-angle or straight board connector.

### CROSS REFERENCE TO RELATED APPLICATIONS

This application claims the benefit of the filing date of Provisional Application No. 60/910,178, filed Apr. 4, 2007, the contents of all of which are incorporated by reference herein.

### FIELD OF THE INVENTION

This invention relates generally to power cable connectors, methods of making them, and power cable connector assemblies.

### BACKGROUND OF THE INVENTION

This invention relates generally to power cable connectors. Generally, power cable connectors mate with board mounted headers to transfer power from a power source to a load. For example, the assignee of this invention, FCI America Technologies, Inc., (FCI) sells power cable connectors under the trade names PwrBlade® and PwrTwinBlade™.

FCI's Pwr TwinBlade™ product is designed to support applications that demand the supply of high power. This product has a touch-proof design that supports currents of up to 100 Amps per twin-contact. The Pwr TwinBlade product can be mated with either a straight or a right-angle board connector to form a connector system. Further, the Pwr TwinBlade has an active latch for coupling it to a board connector. Also, the design provides capability for termination of various cable diameters and wire sizes of 6 AWG and 10 AWG. While FCI's Pwr TwinBlade™ product has been successful, the need exists for an improved power cable connector.

### SUMMARY OF THE INVENTION

This invention relates to an improved power cable connector. In an embodiment, the improved power cable connector of this invention has a housing comprising a bottom portion and a top portion and a plurality of passages that are each used for receiving a receptacle contact. The housing further comprises a plurality of quick-disconnect contacts each disposed in one of the passages that are for mating with receptacle contacts. The quick disconnects permit the power cable connector to be quickly disconnected from the receptacle connector. Preferably, the power cable connector has five quick disconnects.

The invention may also include a cover that is coupled to the housing. In an embodiment, the cover may comprise a top portion and a bottom portion; and a strain relief member, disposed between the cover top and bottom portions. The strain relief member preferably has a plurality of channels, and power cables that extend through the cover channels to the quick disconnects. The power cable connectors are mechanically and electrically connected to the quick-disconnects to transfer power from a power source through the quick disk-connects and to the receptacle.

In addition, the invention may also include a latching spring, coupled to the housing, for attaching a receptacle connector to the housing. The latching spring provides a spring release connection for coupling the cable connector to a receptacle contact. In an embodiment, the latching spring comprises dual latches that are disposed off-center from the housing center line.

The power cable connector quick disconnects can mate with a variety of receptacle connector contacts. For example, the receptacle connector contacts may be blade contacts that mate with the quick disconnects. This invention can include the system that is formed by mating with the power cable connector with the receptacle connector, which may be either a straight or right-angle board connector.

Preferably, the latching springs attach the power cable connector to the receptacle connector. The receptacle connector may have a plurality of holes, so that when the receptacle connector is attached to the power cable connector the latch springs deflect into the holes to couple the cable connector to the receptacle connector. In order to release the cable connector, the springs are deflected downward out of the holes thereby releasing the receptacle connector from the cable connector.

This invention also includes a method of assembling a power cable connector. Preferably, this inventive method uses top loading to manufacture the power cable connector. The method may include the steps of threading the power cables through channels in a strain relief member and threading the cables through lacthing springs. Following this step, quick disconnects are attached, preferably by crimping, onto the power cables. Afterwhich, the quick disconnects may be placed in slots in the cable connector housing. Preferably, the cable connector housing has two parts and the slots are disposed in the housing bottom portion. This permits a top loading manufacturing method to be sued to install the quick disconnects. After installing the quick disconnects, the housing top portion may be attached to the housing bottom portion.

A bottom cover may then be installed under the strain relief member. After which, a top cover is preferably attached to the bottom cover. In a preferred embodiment, one or more mechanical fasteners are used to attach the top cover to the bottom cover.

### BRIEF DESCRIPTION OF THE DRAWINGS

FIG. 1 is a perspective view of a power cable connector and a mating receptacle connector according to a preferred embodiment of this invention;

FIG. 2 is a perspective view of a power cable connector and a mating receptacle connector according to a preferred embodiment of this invention;

FIG. 3 is an exploded view of the power cable connector of FIG. 1 according to a preferred embodiment of this invention;

FIG. 4 is a perspective view of the contacts and cable of the power cable connector of FIG. 1 according to a preferred embodiment of this invention;

FIG. 5 is a perspective view of parts of the power cable connector of FIG. 1 according to a preferred embodiment of this invention;

FIG. 6 is a perspective view of a bottom portion of the housing of the power cable connector of FIG. 1 according to a preferred embodiment of this invention;

FIG. 7 is a perspective view of the top portion of the housing of the power cable connector of FIG. 1 according to a preferred embodiment of this invention;

FIG. 8 is a perspective view of parts of the power cable connector of FIG. 1 according to a preferred embodiment of this invention;

FIG. 9 is a perspective view of parts of the power cable connector of FIG. 1 according to a preferred embodiment of this invention;

FIG. 10 is a perspective view of parts of the power cable connector of FIG. 1 according to a preferred embodiment of this invention;

FIG. 11 is a perspective view of a power cable connector and a mating receptacle connector according to a preferred embodiment of this invention;

FIG. 12A is a top view of the power cable connector of FIG. 1 according to a preferred embodiment of this invention;

FIG. 12B is a back view of the power cable connector of FIG. 1 according to a preferred embodiment of this invention;

FIG. 12C is a side view of the power cable connector of FIG. 1 according to a preferred embodiment of this invention;

FIG. 12D is a perspective view of the power cable connector of FIG. 1 according to a preferred embodiment of this invention;

FIG. 13 is an exploded view of the power cable connector of FIG. 1 according to a preferred embodiment of this invention;

FIG. 14 is a perspective view of a second embodiment of a receptacle connector for mating with the power cable connector;

FIG. 15 is a perspective view of the embodiment of FIG. 14;

FIG. 16A is a perspective view of a first preferred embodiment of a blade contact of a receptacle connector for mating with the power cable connector according to a preferred embodiment of this invention;

FIG. 16B is a perspective view of the preferred embodiment of FIG. 16A;

FIG. 16C is a perspective view of a second preferred embodiment of a blade contact of a receptacle connector for mating with the power cable connector according to a preferred embodiment of this invention;

FIG. 16D is perspective view of the preferred embodiment of FIG. 16C;

FIG. 16E is a perspective view of a third preferred embodiment of a blade contact of a receptacle connector for mating with the power cable connector according to a preferred embodiment of this invention;

FIG. 16F is a perspective view of the embodiment of FIG. 16E;

FIG. 17 is a perspective view of the embodiment of FIG. 16A;

FIG. 18 is a top view of the preferred embodiment of FIG. 17;

FIG. 19 is a top view of the preferred embodiment FIG. 16B;

FIG. 20 is a side view of a preferred embodiment of a blade contact of a receptacle connector for mating with the power cable connector according to a preferred embodiment of this invention according to FIG. 16A;

FIG. 21 is a perspective view of the preferred embodiment of FIG. 16B;

FIG. 22 is a side view of a preferred embodiment of the contact of preferred embodiment of FIG. 17 according to a preferred embodiment of this invention during the manufacturing process with a carrier;

FIG. 23 is a side view of the preferred embodiment of the contacts of FIG. 22 during the manufacturing process according to a preferred embodiment of this invention;

FIG. 24 is a side view of the preferred embodiment of the contacts of FIG. 22 during the manufacturing process according to a preferred embodiment of this invention;

FIG. 25 is a side view of the preferred embodiment of the contacts of FIG. 22 according to a preferred embodiment of this invention during the manufacturing process;

FIG. 26 is a side view of the preferred embodiment of the contacts of FIG. 22 according to a preferred embodiment of this invention during the manufacturing process;

FIG. 27 is a side view of the preferred embodiment of the contacts of FIG. 22 according to a preferred embodiment of this invention during the manufacturing process;

FIG. 28 is a side view of the preferred embodiment of the contacts of FIG. 22 according to a preferred embodiment of this invention during the manufacturing process;

FIG. 29 is a perspective view of a preferred embodiment of FIG. 16B;

FIG. 30 is a top view of the preferred embodiment of FIG. 29;

FIG. 31 is a perspective view of the preferred embodiment of FIG. 16C;

FIG. 32 is a side view of the preferred embodiment of FIG. 16C mounted to a strip;

FIG. 33 is a top view of the preferred embodiment of FIG. 31;

FIG. 34 is a top view of the preferred embodiment of FIG. 16D;

FIG. 35 is a perspective view of the preferred embodiment of FIG. 34;

FIG. 36 is a side view of the preferred embodiment of FIG. 16E;

FIG. 37 is a top view of the preferred embodiment of FIG. 16E;

FIG. 38 is a top view of the preferred embodiment of FIG. 16F; and

FIG. 39 is a side of the preferred embodiment of FIG. 38.

### DETAILED DESCRIPTION OF ILLUSTRATIVE EMBODIMENTS

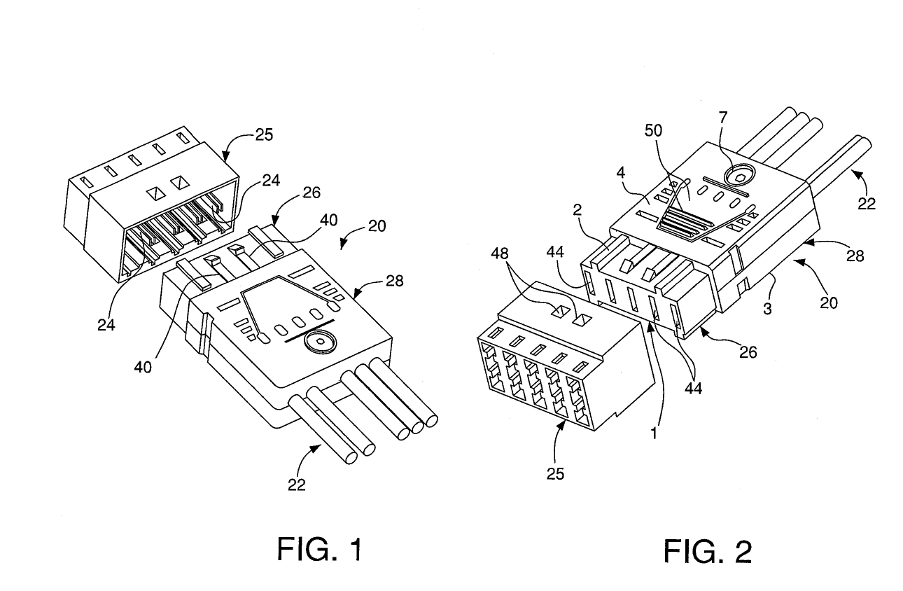

A preferred embodiment of a power cable connector 20 is depicted in FIGS. 1-13. Also depicted in FIGS. 1 and 2 is a receptacle connector 25 that can mate with the power cable connector 20. The receptacle connector 25 can be a board connector and is preferably either a straight board connector a right-angle board connector. The board is not shown, but those skilled in the art will appreciate that any suitable electrical board can be mechanically and electrically coupled to the receptacle connector 25. The power cable connector 20 can be electrically and mechanically connected to the receptacle connector 25 to provide an electrical path from a power source, which is electrically coupled to the power cable connector 20, and a load, which is electrically coupled to the receptacle connector 25.

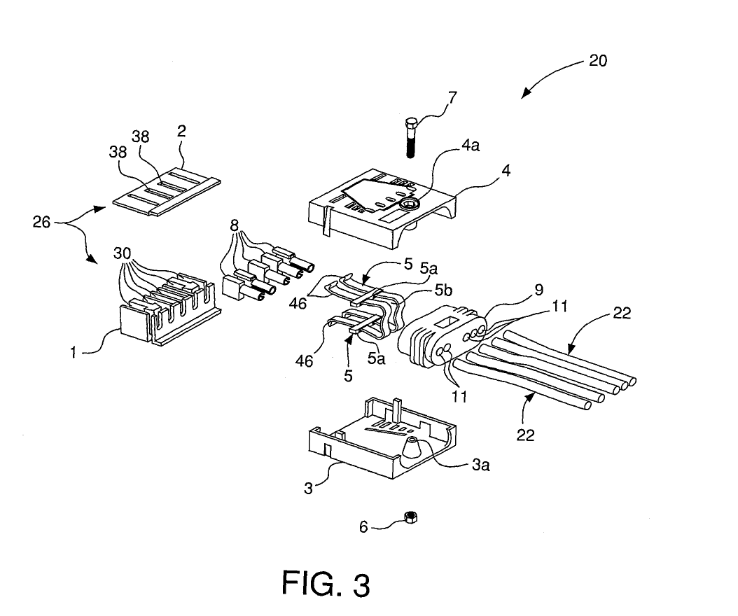

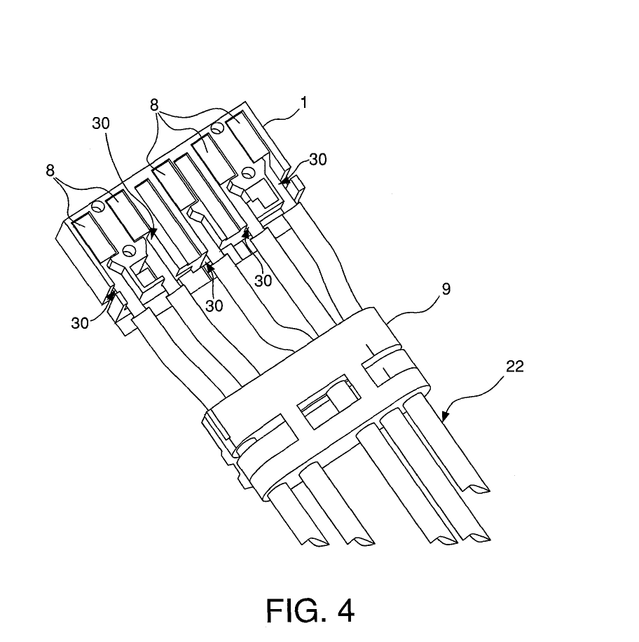

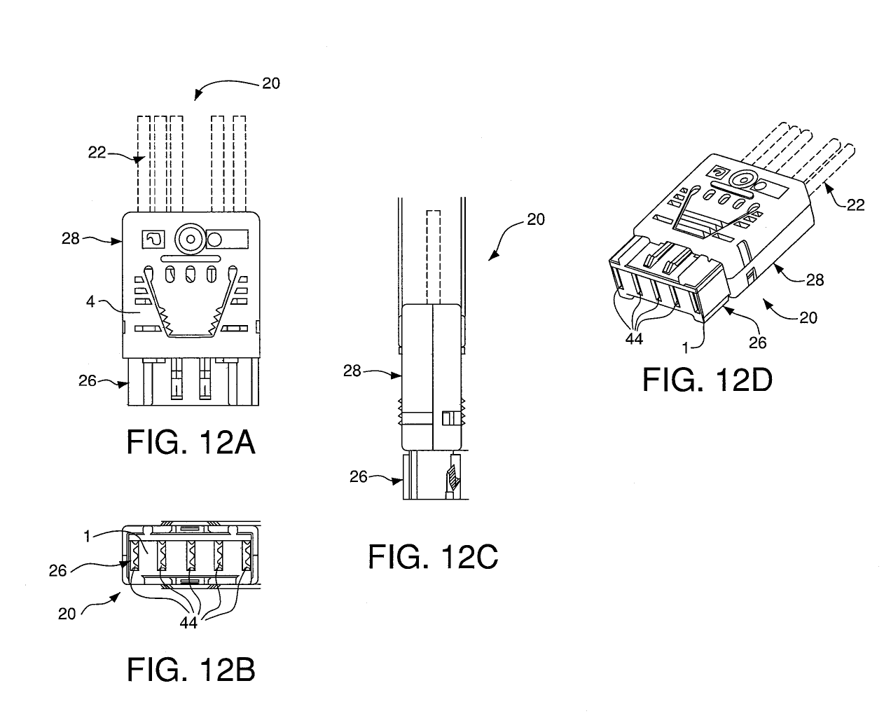

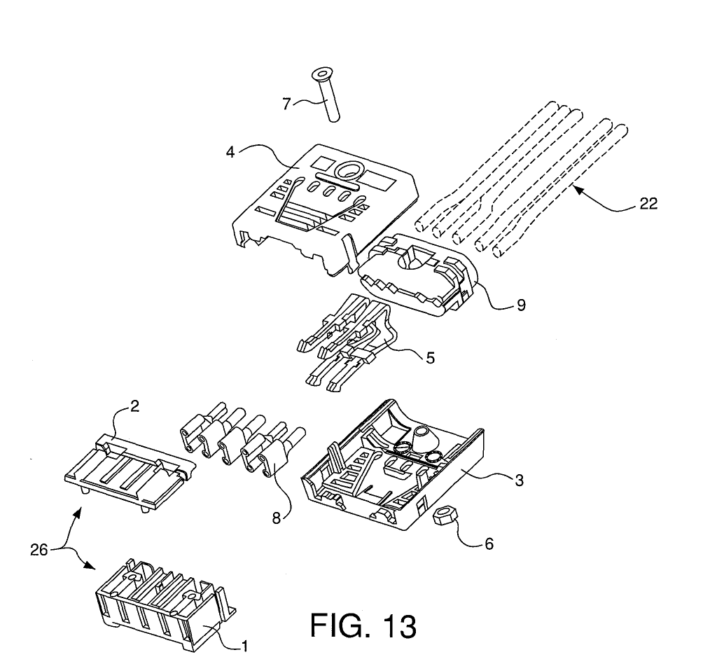

FIGS. 3 and 13 are exploded views of the power cable connector 20 according to a preferred embodiment of this invention and can be used to best understand the components of the preferred embodiment of the power cable connector 20 of this invention. FIGS. 12A-12D are top, front, side and perspective views of the preferred embodiment of this invention and can also be used to understand the components of the preferred embodiment of this invention. FIGS. 4-11 show various preferable components of the power cable connector 20 according to a preferred embodiment and will be referenced as those elements are explained below.

In the preferred embodiment shown, the connector 20 comprises a housing 26 and a cover 28, as shown in FIGS. 1 and 2. Preferably, the housing 26 has a bottom portion 1 and a top portion 2, as shown in FIGS. 3 and 13. The housing bottom and top portions 1, 2 can be constructed form any suitable material, and in a preferred embodiment they are high temperature nylon. The housing bottom and top portions 1, 2 are best shown in FIGS. 6 and 7. The housing top portion 2 can be attached to the housing bottom portion 1 by any of a variety of means including fasteners or adhesives. The bottom portion 1 and the top portion 2 can include features that help to properly align the top portion 2 and the bottom portion 1. For example, the top portion 2 can have a plurality of projections 34, as shown in FIG. 7, and the bottom portion 1 can have a plurality of holes 36, as shown in FIG. 6, that each receive a corresponding projection 34 when the top portion 2 and the bottom portion 1 are properly aligned.

The housing bottom portion preferably has a plurality of slots 30 as shown in FIG. 6. As is best understood with reference to FIGS. 3, 4 and 6, disposed within the slots 30 are a plurality of quick disconnects 8. The quick disconnects 8 are mechanically and electrically connected to the power cables 22, as is best understood with reference to FIGS. 3 and 4. The quick disconnects 8 or contacts are for mating with receptacle contacts to provide an electrical connection between the receptacle and the power cables. In the preferred embodiment shown, there are five quick disconnects 8, but it will be appreciated that any number of quick disconnects 8 and associated power cables can be used. It will also be appreciated that contacts other than quick disconnects can be used in alternative embodiments. The quick disconnects 8 are constructed from any suitable electrical conductive material and most preferably tin-plated brass.

The housing bottom portion 1 can include surfaces 32, shown in FIG. 6, that engage complementary surfaces on the contacts 8. These surfaces 32 help to center each contact 8 within its associated passage 30, and resist mating and un-mating forces that could otherwise displace the contacts 8 from their proper positions within the bottom portion 1 of the housing 26.

The bottom portion 1 of the housing 26 has slots 44, as shown in FIG. 3, formed therein that permit the blades 24 of the receptacle connector 25 to enter the housing and engage the connectors 8 when the power cable connector 20 and the receptacle connector are mated.

Disposed within the power cable connector 20 is a strain relief member 9, as depicted in FIG. 3. The strain relief member 9 can be made of any suitable material such as an electrometric material or nylon. The strain relief member 9 preferably has passages 11 that extend through the strain relief member 9, as shown in FIG. 3. The passages may be off center from the centerline of the power cable connector 20, so that there is sufficient space for the latch springs 5 as explained below.

As shown in FIGS. 1-4, power cables 22 extend through the passages 11 in the strain relief member 9. It will be appreciated that the power cables 22 are connected to a power source, which is not shown. The power cables can be any suitable cables, but in a preferred embodiment they are 12 gage wire. The power cables 22 preferably extend through the strain relief passages 9 and through a passage 5b defined by the latching springs 5, such that the ends of the power cables 22 extends outside of the strain relief member 9 and are attached to the quick disconnects 8 to provide an electrical path from a power source to the quick disconnects 8, as is best shown in FIG. 4. In a preferred embodiment, the quick disconnects 8 are crimped onto the ends of the power cables 22. It will be appreciated, however, that the quick disconnects can be attached to the power cables 22 by any other suitable means.

The connector 20 further comprises a cover 28 comprising a bottom portion 3 and a top portion 4, as shown in FIG. 3. The cover 28 is preferably constructed from an thermoplastic material and most preferably high temperature nylon. The cover top portion 4 and bottom portion 3 are mated and assembled together as best shown in FIGS. 3, 10, and 11. It will be appreciated that any suitable means can be used to affix the cover top portion 4 to the bottom portion 5. In the preferred embodiment shown a mechanical fastener 7 is used to connect the cover top and bottom portions. The mechanical fastener 7 is preferably a screw and the cover top portion 4 has a hole 4a, shown in FIG. 3, through which the screw extends and the cover bottom portion 5 has a hole 3a, shown in FIG. 3, for receiving the fastener 7. The fastener 7 preferably extends through the hole 3a and a nut 6, shown in FIG. 3, is used to fix the fastener 7 in place and thereby attach the top and bottom cover portions.

Preferably, the connector 20 also comprises latching springs 5, shown in FIGS. 3 and 13 The latching springs function to mechanically connect the connector 20 to the receptacle 25. There are preferably two latching springs 5. The latching springs 5 preferably are made of a resilient material such as a metal or a thermoplastic material and most preferably high temperature nylon. The latching springs 5 may be connected by lateral member 5a. Also, the latching springs 5 may have a beam portion 40 and lips 46 that are for attaching the latching spring to the receptacle assembly.

Although the properties of the latching springs can be tailored to the specific application, in a preferred embodiment, the latching springs are designed to withstand a minimum of 150 newtons of retention forces and permit the connector to release from a receptacle at a maximum of force of 250 newtons. The mating force is approximately 3 pounds per contact in this preferred embodiment, so for the five contact connector shown, the mating force is about 15 lbs.

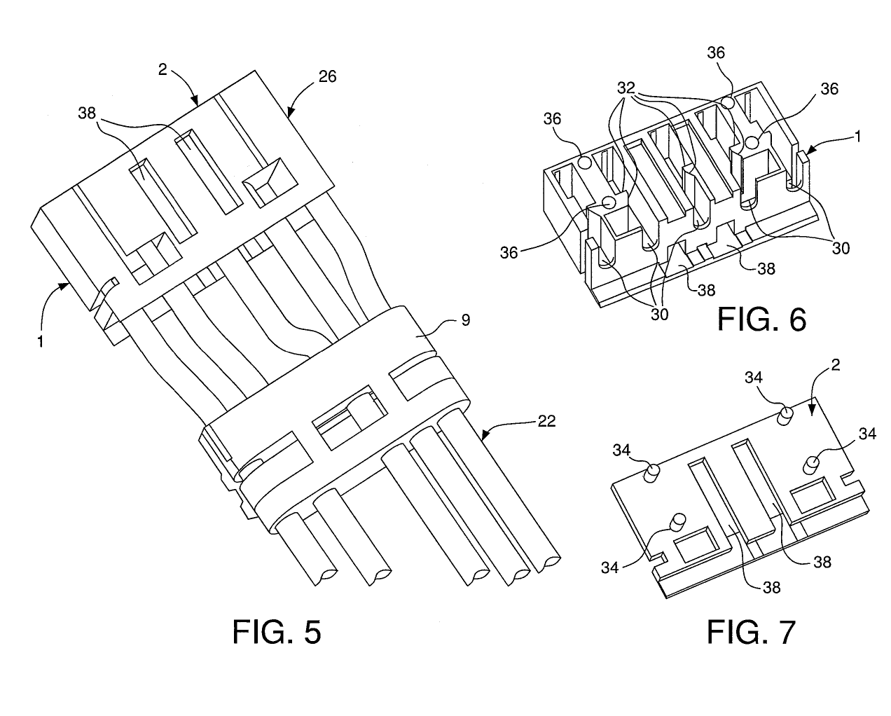

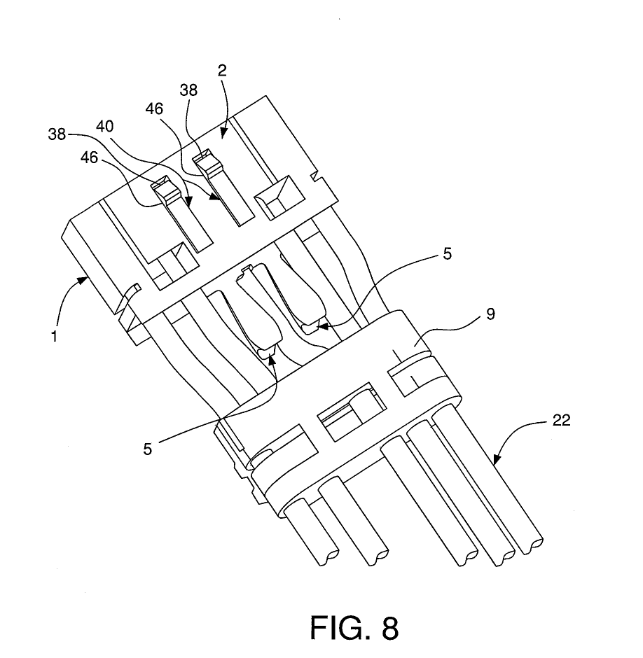

The housing top portion 2 and the housing bottom portion 1 can each have slots 38 formed therein as shown in FIGS. 5-7. Each slot 38 receives an associated beam portion 40 of one of the latching springs 5, as is shown in FIG. 8, and is also understood with reference to FIGS. 3 and 13. Although FIG. 8 shows a top perspective showing the beam portions 40 of the latching springs disposed in the slots 38 of the top housing portion, it will be appreciated from FIGS. 3 and 5-7 that the beam portions of the latching springs are also disposed in the slots 38 of the housing bottom portion shown in FIG. 6.

Preferably, the latching springs 5 are located off-center of the centerline axis of the power cable connector, i.e., the latching springs 5 are located to the sides of the connector 20. Preferably, this arrangement facilitates a smaller form-factor and permits one of the power cables to be in-line with the centerline of the power connector when it mates with a quick disconnects, but off-center line through the strain relief member.

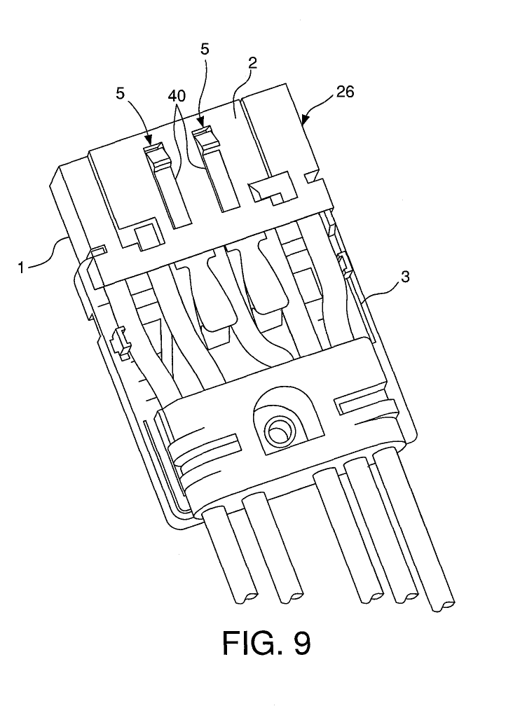

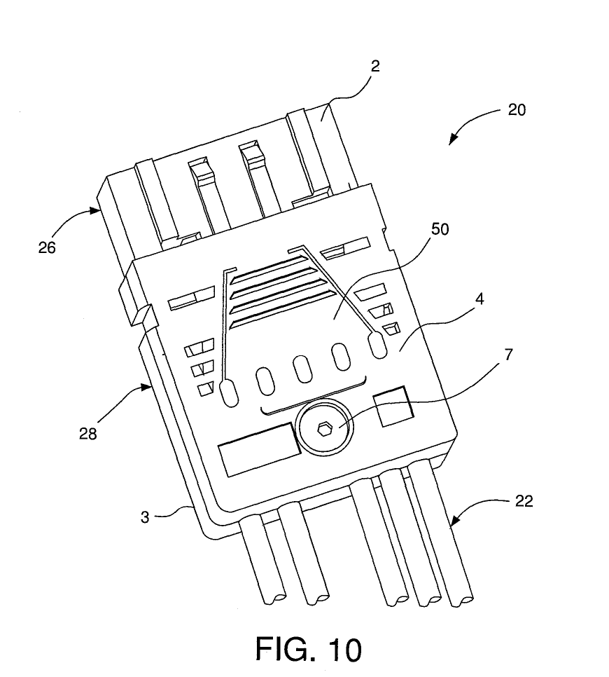

The cover top portion 4 has a tab 50, as shown in FIG. 10. Likewise, the cover bottom portion also has a similar tab. Although the cover bottom tab is not shown in FIG. 10, it will be appreciated that it is similar to the cover top tab. The tabs 50 are positioned over or under the latching springs 5. The tabs 50 can be used to release the latching springs 5 and therefore the power cable connector from a receptacle connector. This is accomplished by depressing the tabs 50 and thereby causing the spring beam portions 40 to move inwardly toward each other. As the spring beam portions 40 move toward each other, the lips 46 disengage from the associated slots 48 in the housing of the receptacle connector 25.

As shown in FIG. 3, the beam portions 40 of the springs each include a lip 46 proximate an end thereof. The lips 46 each become disposed in an associated slot 48 (shown in FIG. 2) in the housing of the receptacle connector 25 when the power cable connector 20 is mated with the receptacle connector 25. Contact between the lips 46 and the adjacent surfaces of the receptacle housing helps the power cable connector 20 and the receptacle connector 25 to remain in a mated condition.

The bottom portion 3 and the top portion 4 of the cover 28 each include a tab portion 50. As is best understood with reference to FIG. 3, the tab portions 50 are positioned over or under the latching springs 5, so that pressing or squeezing the tab portions 50 compresses the latching springs 5 and causes the beam portions 40 to move inwardly, toward each other, so as to cause the lips 46 to become disengaged from the associated slots 48 in the housing of the receptacle connector 25.

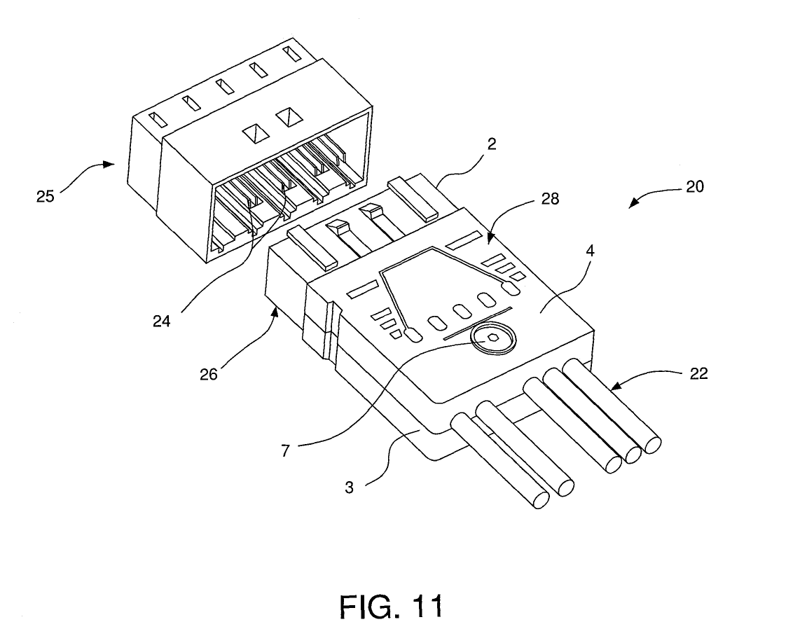

In operation, the power cable connector 20 is connected to a receptacle connector 25 as is best understood with reference to FIGS. 2 and 11. As the power cable connector 20 and the receptacle connector 25 are mated, the lips 46 of the latching springs are deflected and released into the slots 48 of the receptacle. Also, the receptacle contacts 24 are received into the housing slots 44 and mate with the quick disconnects 8 to form an electrical connection between the receptacle connector 25 and the power connector 20.

In order to release the power cable connector 20, the lips 46 are deflected downward to move the lips 46 out of the receptacle connector slots 48. Also, the power plug connector 20 is moved away from the receptacle connector 25 disconnecting the quick disconnects 8 from the receptacle contacts 24.

The inventive method of assembly of the preferred embodiment of this invention is now explained with reference to FIGS. 4-12. As shown in FIG. 4, the power cables 20 are passed through the passages in the strain relief member 9. The quick disconnects 8 are then preferably crimped onto the ends of the power cables 22. Following this, the quick disconnects 8 are disposed in the slots 30 in the housing bottom portion 1. The housing top portion 2 is then aligned with the housing bottom portion as best understood with reference to FIGS. 6 and 7. The members 34 of the top portion 2 are disposed in the mating holes 36 in the bottom portion. After the top portion 2 is attached to the bottom portion, the assembly state is shown in FIG. 5.

The latching springs 46 are then attached by disposing the beam and lip portions in the housing slots as shown in FIG. 8. Next, the cover bottom portion 3 is placed underneath the strain relief member 8 as shown in FIG. 9. The cover top portion is then affixed to the cover bottom portion to cover the strain relief member 8 as shown in FIG. 10. This is preferably done by mechanically fastening the fastener 7 to the nut 8. FIG. 11 shows the connector 20 assembled according to a preferred embodiment of the invention.

Each contact 8 can be loaded into the associated slot 30 from above, from the perspective of FIGS. 4 and 6. Consequently, the method of this invention is preferably a top loading assembly method.

The connector 20 can be mated with the receptacle connector 25, such as that shown in FIG. 1 or 11, to form a connector system. It will be appreciated that the power plug connector 20 can be mated with a variety of receptacle connectors such as board connectors that are preferably either right-angle or straight connectors. Also, it will be appreciated that the connector 20 can be mated with a receptacle connector having any of a variety of receptacle contacts, and the power connector 20 and its quick disconnects 8 can be sized and shaped to received those receptacle contacts.

FIG. 14 is a front perspective view of a receptacle assembly 20 that the power contact of this invention can mate with, and FIG. 15 is back perspective view of this assembly. This embodiment has three power cables 22, and three corresponding contacts.

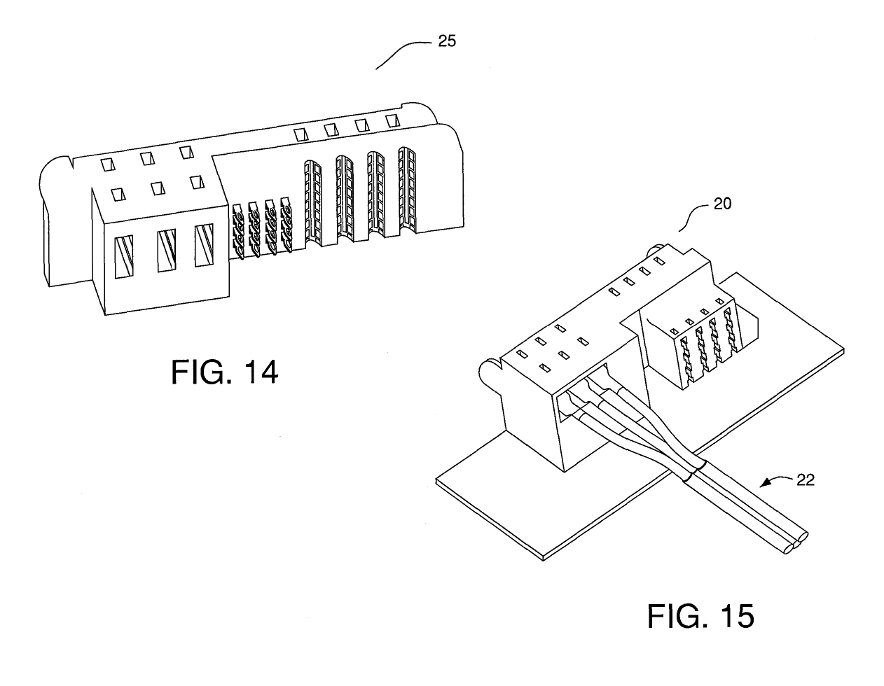

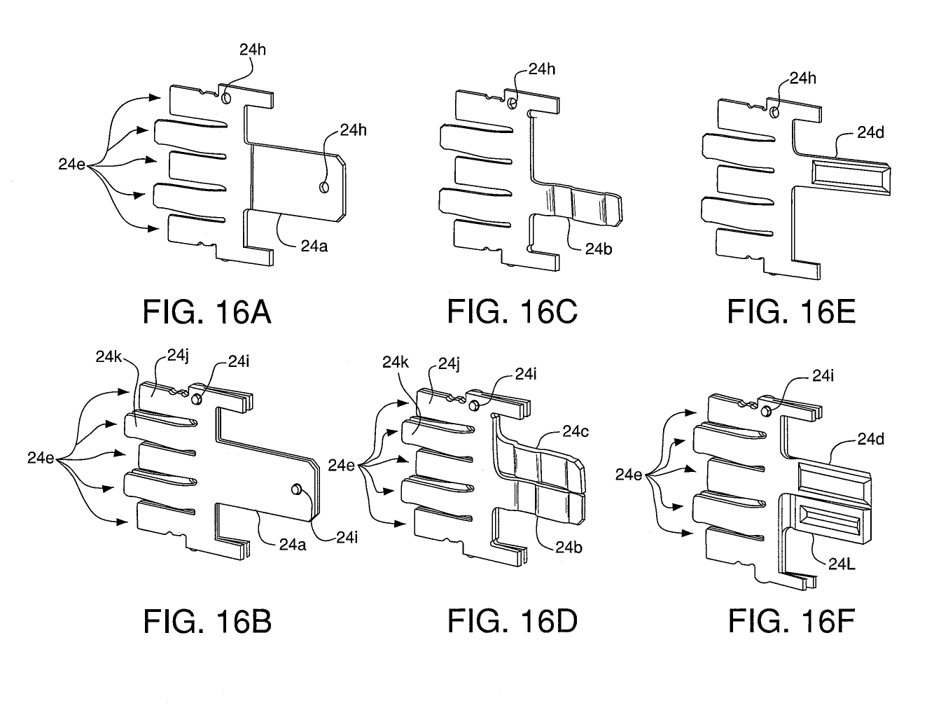

FIGS. 16A-16F depict three embodiments of a receptacle contact 24 with which the power plug contacts of this invention can mate. FIGS. 16A, 16C, and 16E are three different embodiments and these figures shown half of the contact. FIGS. 16B, 16D, and 16F depict both halves of the contact assemblies. In these embodiments, the receptacle contact has five pairs of beams 24e as shown in FIGS. 16B, 16D, and 16F. FIGS. 16A, 16C, and 16E are three different embodiments and these figures shown half of the contact. These halves each have a hole 24h. FIGS. 16B, 16D, and 16F depict both halves of the contact assemblies. As shown the other halves of the contact assemblies have a boss 24i that mates with the hole 24h to form the contact.

In these embodiments, the receptacle contact has five pairs of beams 24e as shown in FIGS. 16B, 16D, and 16F. Preferably, the pairs of contact beams are alternating between parallel contact beams 24j and shaped contact beams 24k. The shaped contact beams 24k preferably extend outward from each other, then inward toward each other, and then away from each other as shown in FIGS. 16B, 16D, and 16F. Although an embodiment of the quick disconnects is shown for the power plug connector, it will be appreciated that the power plug quick disconnects can be similar and corresponding to the receptacle contacts so that they can mate with the receptacle contacts. For example, the power plug quick disconnects may have fives pairs of contact beams that alternate in a pattern opposite to the receptacle contacts.

Also, each receptacle contact of FIGS. 16A, 16B, and 16C has a different contact portion dependent upon the specific application. In the embodiment of FIGS. 16A and 16B, the contact portion 24a comprises parallel beams that mate with each other by having one of the beams having a hole 24f and the other having a boss 24g that mates with the hole 24f as shown. Alternatively, the receptacle contacts can have flexible contact portions 24c, and 24d as shown in FIG. 16D. These contact portions 24c, 24d are preferably flexible and have ends that are bent in an alternating fashion as shown. In a third preferred embodiment, the contact portions 24d, 24l as shown in FIG. 16F are disposed in a stacked arrangement and are parallel to each other.

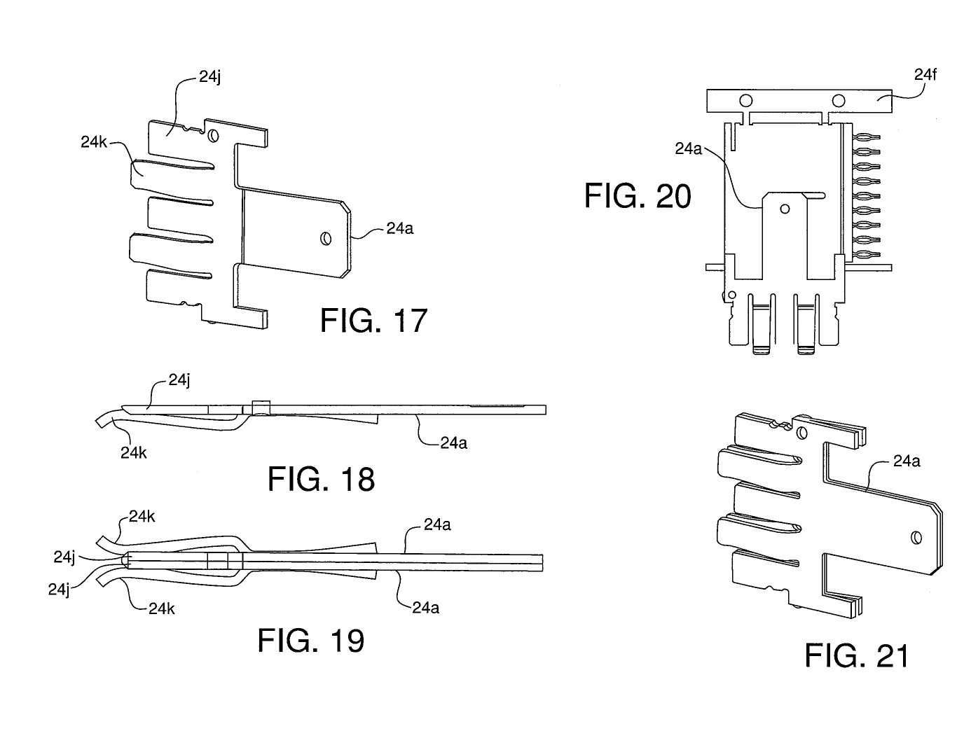

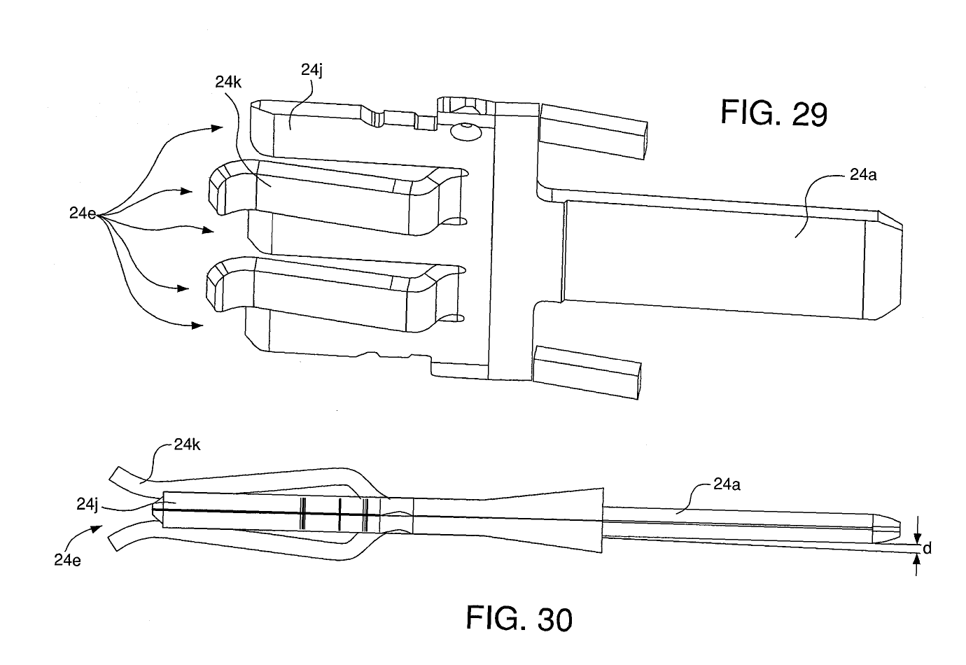

FIGS. 17-21 are additional drawings of the embodiment of FIG. 16A. FIG. 18 is a top view of the half of the assembly of FIG. 17, and FIG. 19 is a top view of the entire receptacle contact. FIG. 19 also shows the alternating contact beams 24j, 24k. FIG. 20 depicts half of the contact assembly of FIG. 17 during manufacturing with a carrier 24f attached. FIG. 29 is a perspective view of the contact assembly of FIG. 16B, and FIG. 30 is another top view of this assembly. As shown in FIG. 30, the contact portion 24 a may be have an angle so that it is offset by a distance d. This facilitates mating with a receptacle.

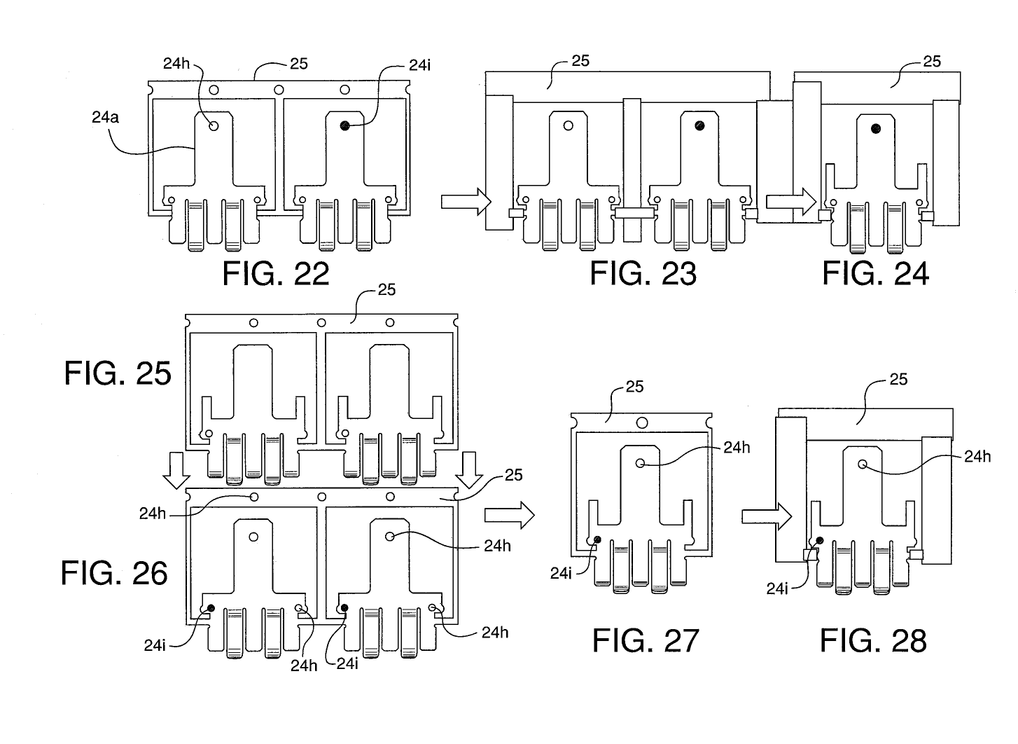

It will be appreciated that any number of conventional manufacturing processes can be used to form contacts for use with the power plug connector and a mating receptacle according to a preferred embodiment of this invention. FIGS. 22-28 show the part of the manufacturing process for one of the preferred embodiments shown. FIG. 22 shows a pair of mating contact halves. On the left is the embodiment of FIG. 16A that has a hole mating 24h, and on the right is a contact half with a mating boss 24i. FIG. 22 shows the two contact halves held by a contact carrier 25. FIGS. 23 and 24 shown the contact halves of FIG. 22 being mated together as shown with the contact carrier 25 attached. FIGS. 25 and 26 depict the contacts being punched or stamped to form the mating holes 24h and FIGS. 27 and 28 depict the contact pairs separated during the manufacturing process. These processes are shown for illustrative purposes and other processes can be used.

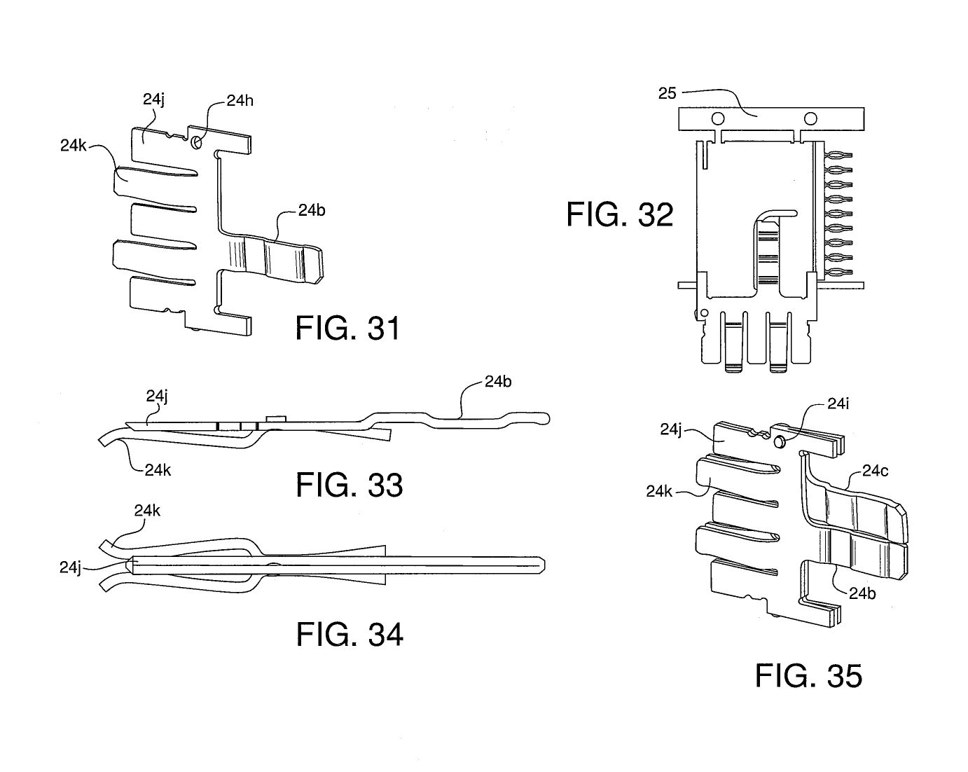

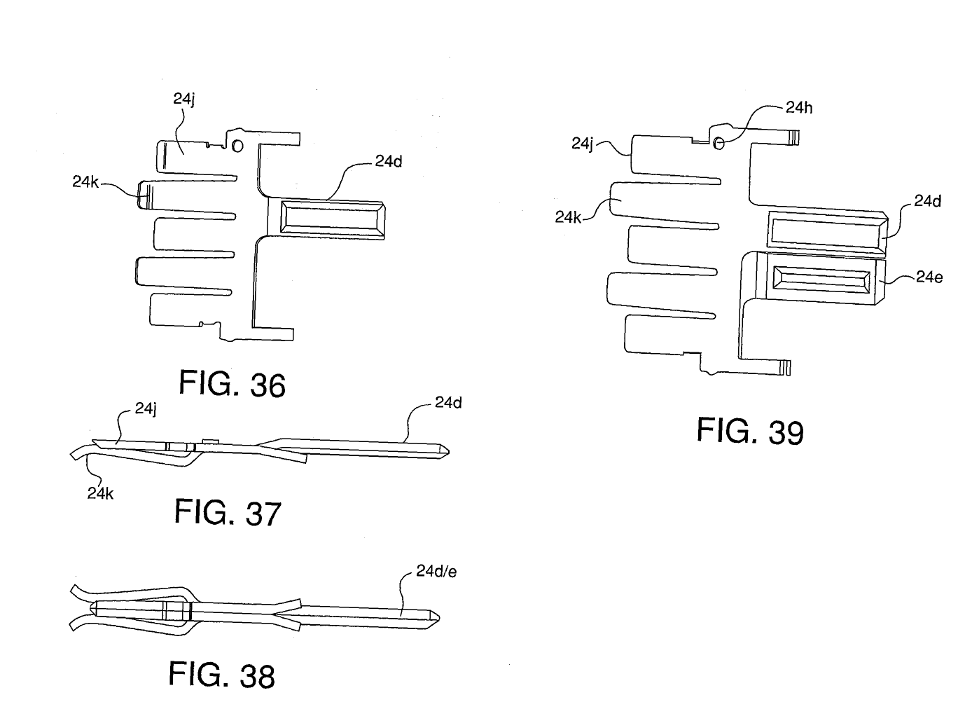

FIGS. 31-35 are additional views of the receptacle contact assembly of FIGS. 16C and 16D. FIGS. 36-39 are additional views of the receptacle contact assembly of FIGS. 36-39.

FIGS. 14-39 depict various receptacle contacts with which the contacts 8 of the power cable connector 20 can be mated. The blade or blades of these power contacts are denoted in the figures by the numerical reference character 24, followed by an alphabetical character. The power contacts can include various combinations of straight and angled contact beams as disclosed in U.S. application Ser. No. 11/408,437, the contents of which is incorporated by reference herein in its entirety. Power contacts having blades with which the contacts 8 of the connector 20 can be mated are also disclosed in U.S. application Ser. No. 11/054,206, the contents of which is incorporated by reference herein in its entirety.

The foregoing description is provided for the purpose of explanation and is not to be construed as limiting the invention. While the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, may effect numerous modifications to the invention as described herein, and changes may be made without departing from the scope and spirit of the invention as defined by the appended claims.

What is claimed:

1. A power cable connector, comprising:
a housing comprising a top, a bottom, a plurality of openings disposed in the top and the bottom, and a plurality of slots;
a plurality of quick disconnect contacts with each quick disconnect disposed in one of the housing slots;
a plurality of latches that each comprise a lip that each extend through one of the housing openings, the latches being for mating the connector with a mating connector;
a cover, coupled to the housing;
a strain relief member disposed within the cover and comprising a plurality of passages; and
a plurality of cables, each cable being connected to one of the quick disconnects and extending through one of the strain relief members slots.

2. The power cable connector of claim 1, wherein the housing top comprises projections that are disposed in holes disposed in the housing bottom.

3. The power cable connector of claim 1, wherein the cover comprises a top cover and a bottom cover that are mated together.

4. The power cable connector of claim 3, further comprising a fastener that assembles the top cover to the bottom cover.

5. The power cable connector of claim 1, wherein the latches comprise springs.

6. The power cable connector of claim 1, wherein the plurality of latches comprise beams that are coupled to the latch lips that are for mating with a receptacle connector.

7. The power cable connector of claim 6, wherein the cover comprises flexible tabs and the latch beams are disposed at least partially proximal to the cover tabs so that the cover tabs can be depressed to deflect the latch beams and thereby release the connector from the mating connector.

8. The power cable connector of claim 6, wherein the power cable connectors are disposed off the connector centerline and one of the quick disconnect contacts is mounted along the centerline of the power cable connector.

9. A power connector system, comprising:
a plug connector, comprising:
a plug housing comprising a top, a bottom, a plurality of openings disposed in the top and the bottom, and a plurality of slots;
a plurality of quick disconnect contacts with each quick disconnect disposed in one of the housing slots;
a plurality of latches that each comprise a lip that each extend through one of the plug housing openings, the latches being for mating the connector with a mating connector;
a cover, coupled to the housing;
a strain relief member disposed within the cover and comprising a plurality of passages;
a plurality of cables, each cable being connected to one of the quick disconnects and extending through one of the strain relief members slots; and
a receptacle connector, comprising:
a receptacle housing comprising a plurality of holes through which the latch lips can extend when the plug connector is mated to the receptacle connector;
the receptacle housing is larger than the plug housing and is for extending into the receptacle housing when the plug and receptacle connectors are mated;
a plurality of receptacle contacts, disposed in the receptacle housing, that are for extending into the plug housing and mating with a quick disconnect.

10. The power connector system of claim 10, further comprising a tab, connected to the housing and disposed proximal to the latches, that is for depressing to move the latch lip out from the receptacle holes to release the plug connector from the receptacle connector.

11. The power connector system of claim 9, wherein the housing top comprises projections that are disposed in holes disposed in the housing bottom.

12. The power connector system of claim 9, wherein the cover comprises a top cover and a bottom cover that are mated together.

13. The power cable connector of claim 12, further comprising a fastener that assembles the top cover to the bottom cover.

14. The power cable connector of claim 9, wherein the receptacle contacts comprise at least one pair of parallel beams and at least one pair of beams that extend outward from each other and inward toward each other.

15. The power cable connector of claim 9, wherein the latches comprise springs.

16. The power cable connector of claim 9, wherein the plurality of latches comprise beams that are coupled to the latch lips.

17. The power cable connector of claim 16, wherein the cover comprises flexible tabs and the latch beams are disposed at least partially proximal to the cover tabs so that the cover tabs can be depressed to deflect the latch beams and thereby release the connector from the mating connector.

18. The power cable connector of claim 6, wherein the power cable connectors are disposed off the connector centerline and one of the quick disconnect contacts is mounted along the centerline of the power cable connector.

19. A method of assembling a power cable connector, comprising:
inserting a plurality of power cables through a strain relief member;
attaching each of the power cables to a quick disconnect;
placing each of the quick disconnects into a housing slot;
attaching latches to the housing by disposing the latches in housing openings; and
assembling a cover around the strain relief member and over at least part of the latches.

20. The method of assembling of claim 19, wherein the step of inserting comprises inserting the power cables through passages in the strain relief member.

21. The method of assembling of claim 19, wherein the step of attaching comprises crimping the quick disconnects onto the power cables.

22. The method of assembling of claim 19, wherein the housing slots are disposed in housing bottom portion and the method further comprises attaching a housing top portion to the housing bottom portion.

23. The method of assembling of claim 10, further comprising attaching a second leaf spring to the housing.

24. The method of assembling of claim 19, wherein the step of assembling the cover comprises assembling a cover bottom to a cover top around the strain relief member.
